(19) United States
(12) Patent Application Publication
(10) Pub. No.: US 2022/0378231 A1
(43) Pub. Date: Dec. 1, 2022

(54) Magnetic Wall-Mounted Assembly with Interchangeable Components

(71) Applicant: Shape Shift Wood LLC, Charlotte, NC (US)

(72) Inventors: Paul Derek Miller, Charlotte, NC (US); Emily Marie Siganowich, Concord, NC (US); Paul David Miller, Salisbury, NC (US)

(21) Appl. No.: 17/829,310

(22) Filed: May 31, 2022

Related U.S. Application Data
(60) Provisional application No. 63/195,178, filed on May 31, 2021.

(51) Int. Cl. A47G 1/17; A47G 1/16; F16M 13/02

(52) U.S. Cl. CPC A47G 1/17; A47G 1/1606; F16M 13/022

(57) ABSTRACT

A magnetic wall-mounted assembly includes: an anchor configured to be secured to a wall; a spacer configured to be magnetically coupled to the anchor; a base configured to be magnetically coupled to the spacer; and one or more decorative items configured to be magnetically coupled to the base. Alternatively, a magnetic wall-mounted assembly includes: an integral anchor-spacer component secured to a wall and extending away from the wall; a base configured to be magnetically coupled to the integral anchor-spacer component; and one or more decorative items configured to be magnetically coupled to the base. One or more decorative items preferably is configured to receive and retain an air plant. The base may have a triangular, circular, or rectangular profile. Preferably, a plurality of bases of different profiles and sizes are provided, each of which is configured to be magnetically coupled to the same spacer or integral anchor-spacer component.

### CROSS-REFERENCE TO RELATED APPLICATION

Priority is claimed to provisional U.S. patent application 63/195,178, filed May 31, 2021, which is incorporated herein by reference.

### COPYRIGHT STATEMENT

Any new and original work of authorship in this document—including any source code—is subject to copyright protection under the copyright laws of the United States and other countries. Reproduction by anyone of this document as it appears in official governmental records is permitted, but otherwise all other copyright rights whatsoever are reserved.

### BACKGROUND OF THE INVENTION

The invention generally relates to wall-mounted decor and, in particular, to magnetic wall-mounted assemblies having interchangeable components.

Wall mounting using magnets is known. For example, FIG. 56 discloses two conventional magnets for use, inter alia, in hanging artwork. The magnets comprise neodymium iron boron magnetic material and are plated in nickel-copper-nickel for a shiny corrosion resistant finish. It is also known to magnetically mount spice containers, as seen in FIG. 57; and to magnetically mount planters for air plants as well as other items and knickknacks such as pencils and scissors, as seen in FIG. 58.

It is believed that improvements in magnetic wall-mounting would be desirable and, in particular, improvements that enhance and expand the optionality of the decor for a given magnetic wall-mounted assembly. This and one or more other needs are believed to be addressed by one or more embodiments of the present invention.

### SUMMARY OF THE INVENTION

The invention includes many aspects and features. Moreover, while many embodiments are disclosed relating to, and are described in, the context of the display of air plants, the invention is not limited to use only in such context, as will become apparent from the following summaries and detailed descriptions of aspects, features, and one or more embodiments of the invention. For example, other items of decor may be displayed including photographs, pictures, and other memorabilia; crystals; and abstract geometric shapes.

Accordingly, in an aspect of the invention, a magnetic wall-mounted assembly comprises: (a) an anchor secured to a wall; (b) a spacer magnetically coupled to the anchor; (c) a base magnetically coupled to the spacer; and (d) one or more decorative items magnetically coupled to the base.

In another aspect, a magnetic wall-mounted assembly comprises: (a) an integral anchor-spacer component secured to a wall and extending away from the wall; (b) a base magnetically coupled to the integral anchor-spacer component; and (c) one or more decorative items magnetically coupled to the base.

In a feature, the base has a triangular profile.

In a feature, the base has a circular profile.

In a feature, the base has a rectangular profile.

In a feature, the assembly further comprises interchangeable bases of different sizes and profiles.

In another aspect, a method of mounting for display air plants utilizes a magnetic wall-mounted assembly with interchangeable components as disclosed herein.

In a preferred embodiment, a magnetic wall-mounted assembly includes: an anchor configured to be secured to a wall; a spacer configured to be magnetically coupled to the anchor; a base configured to be magnetically coupled to the spacer; and one or more decorative items configured to be magnetically coupled to the base.

In an alternative preferred embodiment, a magnetic wall-mounted assembly includes: an integral anchor-spacer component secured to a wall and extending away from the wall; a base configured to be magnetically coupled to the integral anchor-spacer component; and one or more decorative items configured to be magnetically coupled to the base.

One or more decorative items preferably is configured to receive and retain an air plant. Additionally, the base may have a triangular, circular, or rectangular profile, and preferably a plurality of bases of different profiles and sizes are provided, each of which is configured to be magnetically coupled to the same spacer or integral anchor-spacer component.

In another aspect, a magnetic wall-mounted assembly comprises: an anchor secured to a wall; a spacer magnetically coupled to the anchor; a base magnetically coupled to the spacer; and a decorative item magnetically coupled to the base. The decorative item and base are separable by pulling the decorative item from the base to decouple them; the base and spacer are separable by pulling the base from the spacer to decouple them; and the spacer and the anchor are separable by pulling the spacer from the anchor to decouple them.

In a feature, the base comprises a piece of wood, within a back recess of which a ferromagnetic plate is contained for magnetic coupling of the decorative item on a front wooden surface of the base.

In a feature, the decorative item comprises a nonmagnetic body within which a magnet is contained for magnetic coupling of the decorative item with the base. The non-magnetic body preferably is made from wood or a plastic material.

In a feature, the apparatus further comprises a support collar secured to the base and surrounding an end of the spacer for supporting the magnetic coupling between the spacer and the base.

In a feature, the apparatus further comprises a gasket secured to an end of the spacer and providing a frictional abutment resisting slippage between the spacer and the base in their magnetic coupling. The gasket preferably is made from rubber, silicone, or other non-slip material.

In a feature, the spacer is attached to the anchor solely by the magnetic coupling between the spacer and the anchor.

In a feature, the base is attached to the spacer solely by the magnetic coupling between the base and the spacer.

In a feature, the decorative item is attached to the base solely by the magnetic coupling between the decorative item and the base.

In a feature, the decorative item comprises a planter. The decorative item preferably comprises an air plant.

In a feature, the decorative item comprises a shelf.

In a feature, the decorative item comprises a staircase shelf.

In a feature, the base has a triangular profile and hides view of the spacer such that the base appears to be floating proximate the wall.

In a feature, the base has a circular profile and hides view of the spacer such that the base appears to be floating proximate the wall.

In a feature, the base has a rectangular profile and hides view of the spacer such that the base appears to be floating proximate the wall.

In another feature, the apparatus further comprises additional decorative items, each additional decorative item being magnetically coupled with the base and separable by pulling the additional decorative item from the base to decouple them.

In a feature, the base comprises a plurality of ferromagnetic plates each contained within a respective recess of a body of the base, and wherein the magnet of the base is centrally located relative to the plurality of ferromagnetic plates of the base.

In another aspect, an apparatus for showcasing an item on a wall, the apparatus comprising a plurality of separate components including: an anchor having a magnet; a spacer having a magnet; and a base having a body containing a magnet and a ferromagnetic material. The anchor is configured to mount to a wall; the spacer is configured to mount to the anchor by magnetic coupling of the magnet of the anchor and the magnet of the spacer; and the base is configured to mount to the spacer by magnetic coupling of the magnet of the spacer and the magnet of the base.

In another feature, the apparatus further comprises a decorative item having a body containing a magnet, wherein the decorative item is configured to mount to the base by magnetic coupling between the magnet of the decorative item and the ferromagnetic material contained within the base.

In a feature, the ferromagnetic material of the base comprises a ferromagnetic plate. The ferromagnetic plate preferably is contained within a recess of a body of the base; the base preferably comprises a plurality of ferromagnetic plates each contained within a respective recess of the body of the base; and the magnet of the base preferably is centrally located relative to the plurality of ferromagnetic plates of the base.

In another aspect, a magnetic wall-mounted assembly comprises: an anchor-spacer component secured to a wall; a base magnetically coupled to the anchor-spacer component; and a decorative item magnetically coupled to the base. The decorative item and base are separable by pulling the decorative item from the base to decouple them; and the base and anchor-spacer component are separable by pulling the base from the anchor-spacer component to decouple them.

In a feature, the base comprises a piece of wood, within a back recess of which a ferromagnetic plate is contained for magnetic coupling of the decorative item on a front wooden surface of the base.

In a feature, the decorative item comprises a nonmagnetic body within which a magnet is contained for magnetic coupling of the decorative item with the base. The non-magnetic body preferably is made from wood or a plastic material.

In another feature, the apparatus further comprises a support collar secured to the base and surrounding an end of the anchor-spacer component for supporting the magnetic coupling between the anchor-spacer component and the base.

In another feature, the apparatus further comprises a gasket secured to an end of the anchor-spacer component and providing a frictional abutment resisting slippage between the anchor-spacer component and the base in their magnetic coupling. The gasket preferably is made from rubber, silicone, or other non-slip material.

In a feature, the anchor-spacer component comprises an integral component that is inseparable without damage thereto.

In a feature, the base is attached to the anchor-spacer component solely by the magnetic coupling between the base and the spacer.

In a feature, the decorative item is attached to the base solely by the magnetic coupling between the decorative item and the base.

In a feature, the decorative item comprises a planter. The decorative item preferably comprises an air plant.

In a feature, the decorative item comprises a shelf.

In a feature, the decorative item comprises a staircase shelf.

In a feature, the base has a triangular profile and hides view of the spacer such that the base appears to be floating proximate the wall.

In a feature, the base has a circular profile and hides view of the spacer such that the base appears to be floating proximate the wall.

In a feature, the base has a rectangular profile and hides view of the spacer such that the base appears to be floating proximate the wall.

In another feature, the apparatus further comprises additional decorative items, each additional decorative item being magnetically coupled with the base and separable by pulling the additional decorative item from the base to decouple them.

In a feature, the base comprises a plurality of ferromagnetic plates each contained within a respective recess of a body of the base, and wherein the magnet of the base is centrally located relative to the plurality of ferromagnetic plates of the base.

In another aspect, an apparatus for showcasing an item on a wall, comprises: an integral anchor-spacer component having a magnet; and a base having a body containing a magnet and a ferromagnetic material. The anchor-spacer component is configured to mount to a wall; and the base is configured to mount to the anchor-spacer component by magnetic coupling of the magnet of the anchor-spacer component and the magnet of the base.

In a feature, the apparatus further comprises a decorative item having a body containing a magnet, wherein the decorative item is configured to mount to the base by magnetic coupling between the magnet of the decorative item and the ferromagnetic material contained within the base.

In a feature, the ferromagnetic material of the base comprises a ferromagnetic plate. The ferromagnetic plate preferably is contained within a recess of a body of the base; the base preferably comprises a plurality of ferromagnetic plates each contained within a respective recess of the body of the base; and the magnet of the base preferably is centrally located relative to the plurality of ferromagnetic plates of the base.

A magnetic wall-mounted assembly comprises: (a) a wall anchor; (b) a spacer; (c) a base; (d) one or more decorative items; and (e) a plurality of means for collectively attaching the foregoing components together for displaying on a wall.

In another aspect, a magnetic wall-mounted assembly comprises: (a) an integral wall anchor-spacer component; (b) a base; (c) one or more decorative items; and (d) a plurality of means for collectively attaching the foregoing components together for displaying on a wall.

In another aspect, a method of mounting for display air plants using the magnetic wall-mounted assembly of any preceding claim.

In another aspect, an apparatus comprises: a decorative item for mounting on a wall; and means for mounting the decorative item on the wall.

In another aspect, a method for mounting a decorative item on a wall comprises the steps of mounting an anchor to a wall; magnetically mounting a spacer to the anchor; magnetically mounting a base to the spacer; and magnetically mounting one or more decorative items to the base.

In a feature, the method further comprises swapping the base with another base having a different profile or size.

In another aspect, a method for mounting a decorative item on a wall comprises the steps of mounting an anchor-spacer component to a wall; magnetically mounting a base to the anchor-spacer component; and magnetically mounting one or more decorative items to the base.

Additional aspects and features are disclosed in the Appendix, which is incorporated herein by reference.

In addition to the aforementioned aspects and features of the invention, it should be noted that the invention further encompasses the various logical combinations and subcombinations of such aspects and features. Thus, for example, claims in this or a divisional or continuing patent application or applications may be separately directed to any aspect, feature, or embodiment disclosed herein, or combination thereof, without requiring any other aspect, feature, or embodiment.

### BRIEF DESCRIPTION OF THE DRAWINGS

One or more preferred embodiments of the invention now will be described in detail with reference to the accompanying drawings.

FIG. 1 is an exploded schematic view of a preferred embodiment in accordance with one or more aspects and features of the invention.

FIG. 2 is an exploded schematic view of another preferred embodiment in accordance with one or more aspects and features of the invention.

FIG. 3 is a front plan view of a base having a rectangular profile of an embodiment in accordance with one or more aspects and features of the invention.

FIG. 4 is a back plan view of the base of FIG. 3.

FIG. 5 is a front plan view of a base having a triangular profile of an embodiment in accordance with one or more aspects and features of the invention.

FIG. 6 is a back plan view of the base of FIG. 5.

FIG. 7 is a front plan view of a base having a circular profile of an embodiment in accordance with one or more aspects and features of the invention.

FIG. 8 is a back plan view of the base of FIG. 7.

FIG. 9 is a front plan view of a base having a rectangular profile of another embodiment in accordance with one or more aspects and features of the invention.

FIG. 10 is a back plan view of the base of FIG. 9.

FIG. 11 is a front plan view of a base having a triangular profile of another embodiment in accordance with one or more aspects and features of the invention.

FIG. 12 is a back plan view of the base of FIG. 11.

FIG. 13 is a front plan view of a base having a circular profile of another embodiment in accordance with one or more aspects and features of the invention.

FIG. 14 is a back plan view of the base of FIG. 13.

FIG. 15 is a back plan view of a base with a circular profile of another embodiment in accordance with one or more aspects and features of the invention.

FIG. 16 is a perspective view of several prototypes of magnetic wall-mounted assemblies in accordance with one or more aspects and features of the invention.

FIG. 17 is a perspective side view of an integral wall anchor and spacer of an embodiment in accordance with one or more aspects and features of the invention.

FIG. 18 is a front perspective view of the integral wall anchor and spacer of FIG. 17.

FIG. 19 is a front perspective view of a prototype assembly including a base with a triangular profile in accordance with one or more aspects and features of the invention.

FIG. 20 is a side perspective view of the assembly of FIG. 19.

FIG. 21 is a back perspective view of the base of the assembly of FIG. 19.

FIG. 22 is a front perspective view of a prototype assembly including a base with a circular profile in accordance with one or more aspects and features of the invention.

FIG. 23 is a side perspective view of the assembly of FIG. 22.

FIG. 24 is a back perspective view of the base of the assembly of FIG. 23.

FIG. 25 is a front perspective view of a prototype assembly including a base with a rectangular profile in accordance with one or more aspects and features of the invention.

FIG. 26 is a side perspective view of the assembly of FIG. 25.

FIG. 27 is a back perspective view of the base of the assembly of FIG. 25.

FIG. 28 is a prototype base of which the embodiment of FIG. 9 is representative.

FIG. 29 is a prototype base of which the embodiment of FIG. 9 is representative.

FIG. 30 is a prototype base of which the embodiment of FIG. 11 is representative.

FIG. 31 is a prototype base of which the embodiment of FIG. 11 is representative.

FIG. 32 is a prototype base of which the embodiment of FIG. 13 is representative.

FIG. 33 is a prototype base of which the embodiment of FIG. 13 is representative.

FIG. 34 is side perspective view of an assembly of an embodiment in accordance with one or more aspects and features of the invention.

FIG. 35 is a side perspective view of another assembly of an embodiment in accordance with one or more aspects and features of the invention.

FIG. 36 is side perspective view of an assembly of an embodiment in accordance with one or more aspects and features of the invention.

FIG. 37 is a side perspective view of another assembly of an embodiment in accordance with one or more aspects and features of the invention.

FIG. 38 is side perspective view of an assembly of an embodiment in accordance with one or more aspects and features of the invention.

FIG. 39 is a side perspective view of another assembly of an embodiment in accordance with one or more aspects and features of the invention.

FIG. 40 is a back perspective view of the base of FIG. 14, wherein a support collar attached to the base is perhaps best seen.

FIG. 41 is a front perspective view of a decorative item comprising a “staircase” in accordance with one or more aspects and features of the invention.

FIG. 42 is a top perspective view of the decorative item of FIG. 41.

FIG. 43 is a back perspective view of the decorative item of FIG. 41.

FIG. 44 is a front perspective view of a decorative item comprising a cup-shaped wall planter in accordance with one or more aspects and features of the invention.

FIG. 45 is a top perspective view of the decorative item of FIG. 44.

FIG. 46 is a back perspective view of the decorative item of FIG. 44.

FIG. 47 is a front perspective view of a decorative item comprising a shelf with channel in accordance with one or more aspects and features of the invention.

FIG. 48 is a top perspective view of the decorative item of FIG. 47.

FIG. 49 is a back perspective view of the decorative item of FIG. 47.

FIG. 50 is a front perspective view of a decorative item comprising a triangular wall planter in accordance with one or more aspects and features of the invention.

FIG. 51 is a top perspective view of the decorative item of FIG. 50.

FIG. 52 is a back perspective view of the decorative item of FIG. 50.

FIG. 53 is a front perspective view of a decorative item comprising a cubic wall planter in accordance with one or more aspects and features of the invention.

FIG. 54 is a top perspective view of the decorative item of FIG. 50.

FIG. 55 is a back perspective view of the decorative item of FIG. 50.

FIG. 56 is a perspective view of two magnets for use, inter alia, in hanging artwork in a conventional manner.

FIG. 57 is a perspective view of magnetically mounted spice containers, in a conventional manner.

FIG. 58 is a perspective view of magnetically mounted planters for air plants as well as other items and knickknacks such as pencils and scissors, in a conventional manner.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once but not necessarily every time during performance of the claimed method.

Furthermore, it is important to note that, as used herein, “comprising” is open-ended insofar as that which follows such term is not exclusive. Additionally, “a” and “an” each generally denotes “at least one” but does not exclude a plurality unless the contextual use dictates otherwise. Thus, reference to “a picnic basket having an apple” is the same as “a picnic basket comprising an apple” and “a picnic basket including an apple”, each of which identically describes “a picnic basket having at least one apple” as well as “a picnic basket having apples”; the picnic basket further may contain one or more other items beside an apple. In contrast, reference to “a picnic basket having a single apple” describes “a picnic basket having only one apple”; the picnic basket further may contain one or more other items beside an apple. In contrast, “a picnic basket consisting of an apple” has only a single item contained therein, i.e., one apple; the picnic basket contains no other item.

When used herein to join a list of items, “or” denotes “at least one of the items” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers”; the picnic basket further may contain one or more other items beside cheese and crackers.

When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”; the picnic basket further may contain one or more other items beside cheese and crackers.

The phrase “at least one” followed by a list of items joined by “and” denotes an item of the list but does not require every item of the list. Thus, “at least one of an apple and an orange” encompasses the following mutually exclusive scenarios: there is an apple but no orange; there is an orange but no apple; and there is both an apple and an orange. In these scenarios if there is an apple, there may be more than one apple, and if there is an orange, there may be more than one orange. Moreover, the phrase “one or more” followed by a list of items joined by “and” is the equivalent of “at least one” followed by the list of items joined by “and”.

Referring now to the drawings, one or more preferred embodiments of the invention are next described. The following description of one or more preferred embodiments is merely exemplary in nature and is in no way intended to limit the invention, its implementations, or uses.

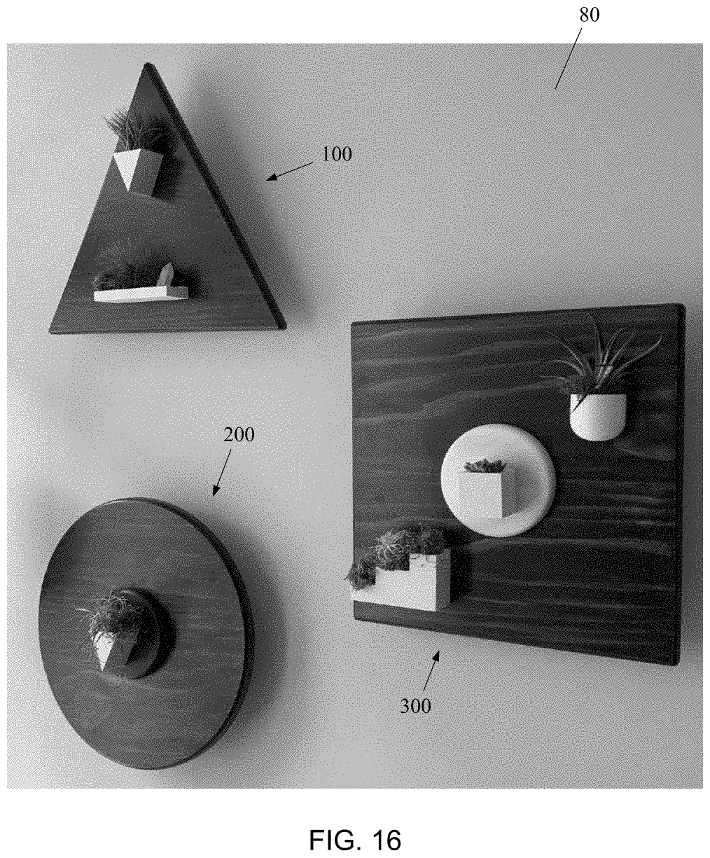

Turning now to the drawings, FIG. 16 is a perspective view of several prototypes of magnetic wall-mounted assemblies 100,200,300 mounted on a wall 80 in accordance with one or more aspects and features of the invention.

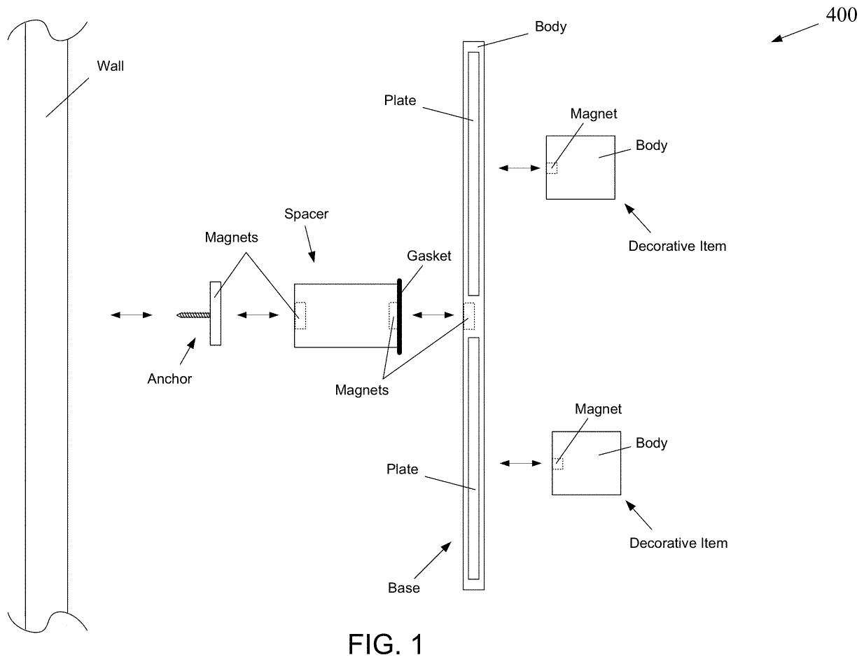

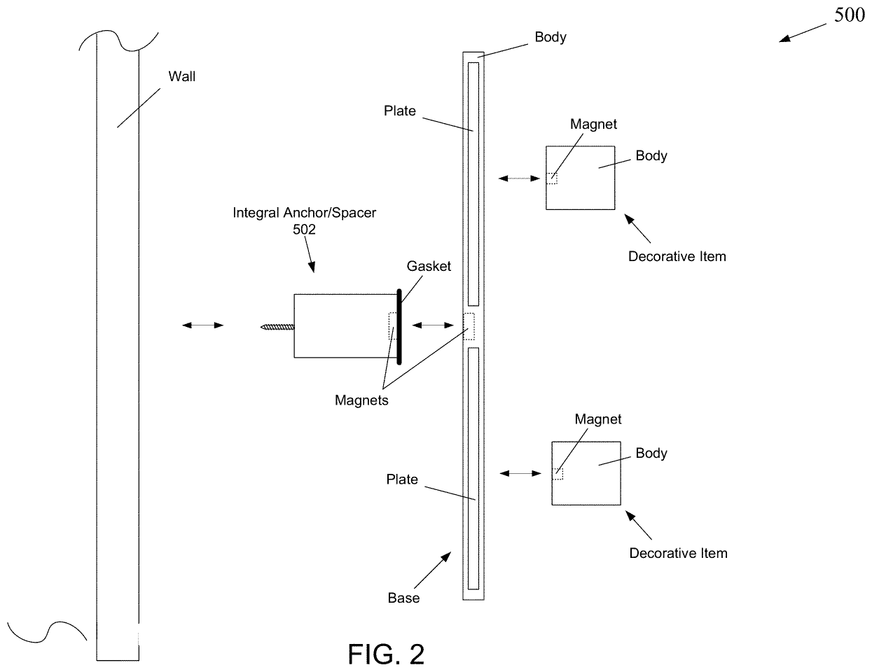

FIG. 1 is an exploded schematic view of a preferred embodiment of a magnetic wall-mounted assembly 400 in accordance with one or more aspects and features of the invention. An alternative preferred embodiment of a magnetic wall-mounted assembly 500 in accordance with one or more aspects and features of the invention is schematically illustrated in FIG. 2. A difference between assembly 400 and assembly 500 is the anchor and spacer are separate components in the assembly 400 but are an integral in FIG. 2. Specifically, in the assembly 400, a magnetic coupling attaches the spacer to the anchor, which in turn is secured to the wall by one or more screws. In the assembly 500, the integral anchor-spacer component 502 is secured to the wall with one or more screws without coupling or otherwise attaching together the anchor and the spacer. The spacer gives the base a floating effect, in that the base appears to be floating at a spacing to a wall when the assembly is mounted to a wall. In some embodiments, the spacer further contains a battery pack and LED lights for backlighting or accent lighting of a base. The LED lights further may be located on the back of the base, with an electrical connection being made to power the lights when the spacer is magnetically coupled with the base.

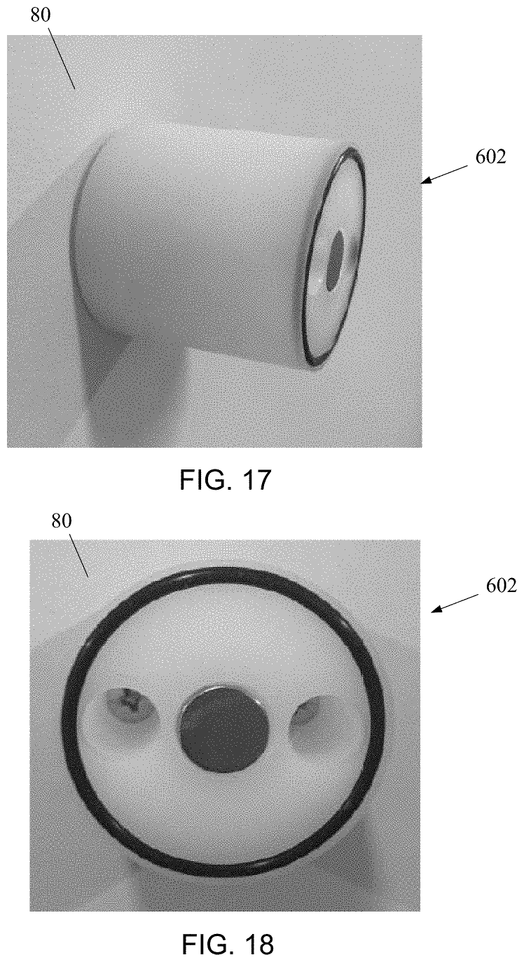

FIG. 17 is a perspective side view of a prototype integral wall anchor-spacer component 602 mounted on the wall 80, of which the integral anchor-spacer component 502 is representative. FIG. 18 is a front perspective view of the integral wall anchor-spacer component 602 mounted on the wall 80.

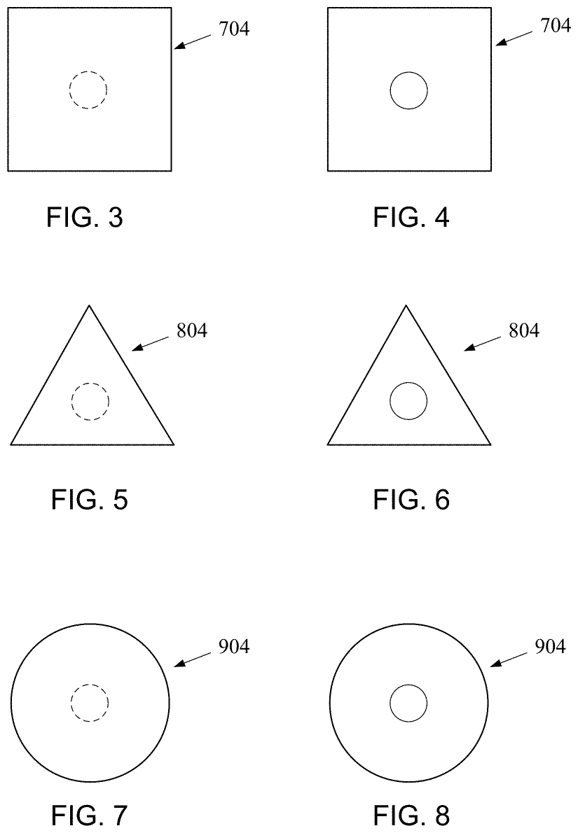

FIG. 3 is a front plan view of a base 704 having a rectangular profile of an embodiment in accordance with one or more aspects and features of the invention. FIG. 4 is a back plan view of the base 704.

FIG. 5 is a front plan view of a base 804 having a triangular profile of an embodiment in accordance with one or more aspects and features of the invention. FIG. 6 is a back plan view of the base 804.

FIG. 7 is a front plan view of a base 904 having a circular profile of an embodiment in accordance with one or more aspects and features of the invention. FIG. 8 is a back plan view of the base 904.

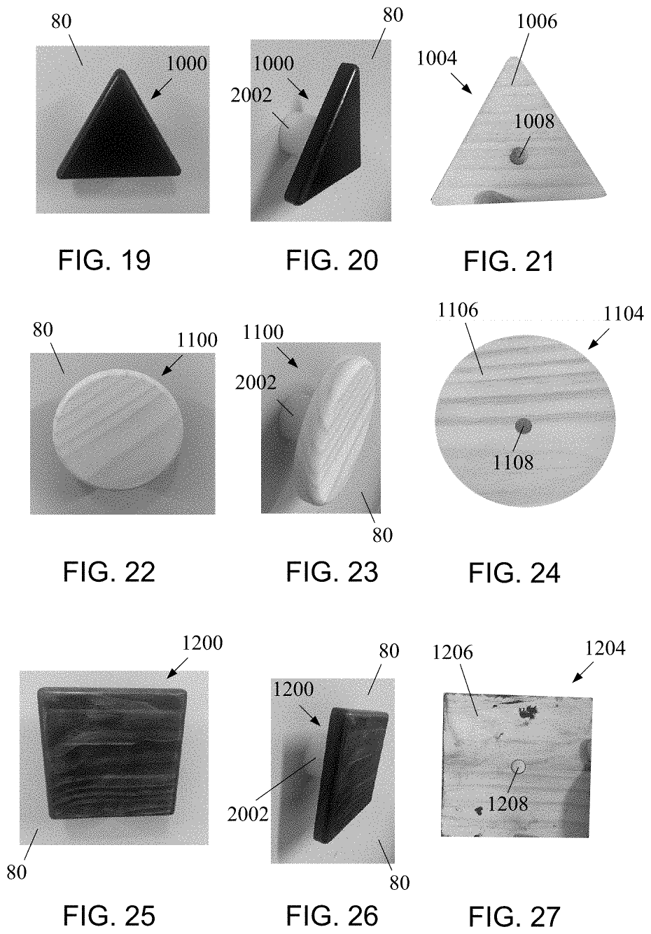

FIG. 19 is a front perspective view of a prototype assembly 1000 mounted on the wall 80 and including a base 1004 with a triangular profile in accordance with one or more aspects and features of the invention. FIG. 20 is a side perspective view of the assembly 1000 mounted on the wall 80, and FIG. 21 is a back perspective view of the base 1004 of the assembly 1000. The base 1004 preferably comprises a piece of wood 1006 having a magnet 1008 centrally retained within a recess formed in the wood.

FIG. 22 is a front perspective view of a prototype assembly 1100 mounted on the wall 80 and including a base 1104 with a circular profile in accordance with one or more aspects and features of the invention. FIG. 23 is a side perspective view of the assembly 1100 mounted on the wall 80, and FIG. 24 is a back perspective view of the base 1104 of the assembly 1100. The base 1104 preferably comprises a piece of wood 1106 having a magnet 1108 centrally retained within a recess formed in the wood.

FIG. 25 is a front perspective view of a prototype assembly 1200 mounted on the wall 80 and including a base 1204 with a rectangular profile in accordance with one or more aspects and features of the invention. FIG. 26 is a side perspective view of the assembly 1200 mounted on the wall 80, and FIG. 27 is a back perspective view of the base 1204 of the assembly 1200. The base 1204 preferably comprises a piece of wood 1206 having a magnet 1208 centrally retained within a recess formed in the wood.

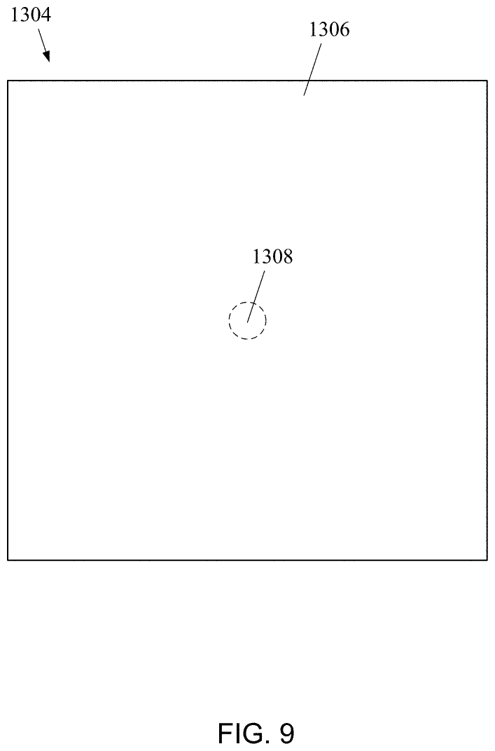

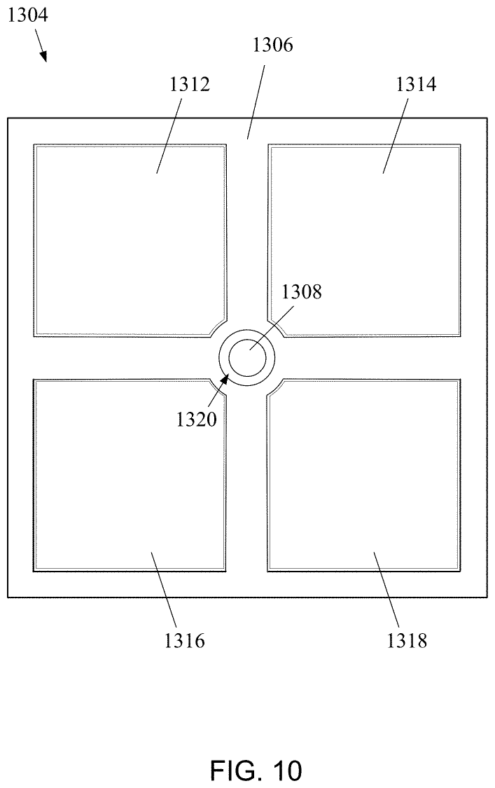

FIG. 9 is a front plan view of a base 1304 having a rectangular profile of another embodiment in accordance with one or more aspects and features of the invention. While similar to base 1204 with respect to having a rectangular profile, base 1304 is much larger in dimension than that of base 1204. Additionally, as seen in FIG. 10, which is a back plan view of the base 1304, the base 1304 comprises a wood frame in which four plates 1312,1314,1316,1318 are contained, each made from a ferromagnetic material. Alternatively, the wood frame could contain a single plate or a different plurality of plates of a ferromagnetic material. The base 1304 further comprises a recessed area 1320 designed to receive therein an end of the spacer or spacer/anchor such that the base 1304 is better secured from slipping or otherwise moving when magnetically coupled with the spacer or spacer/anchor.

A gasket (seen in FIG. 1 and FIG. 3) also may be secured to an end of the spacer or integral anchor-spacer component which preferably is made from rubber, silicone, or another non-slip material and which provides a frictional abutment resisting slippage when the spacer or integral anchor-spacer component is magnetically coupled with a base.

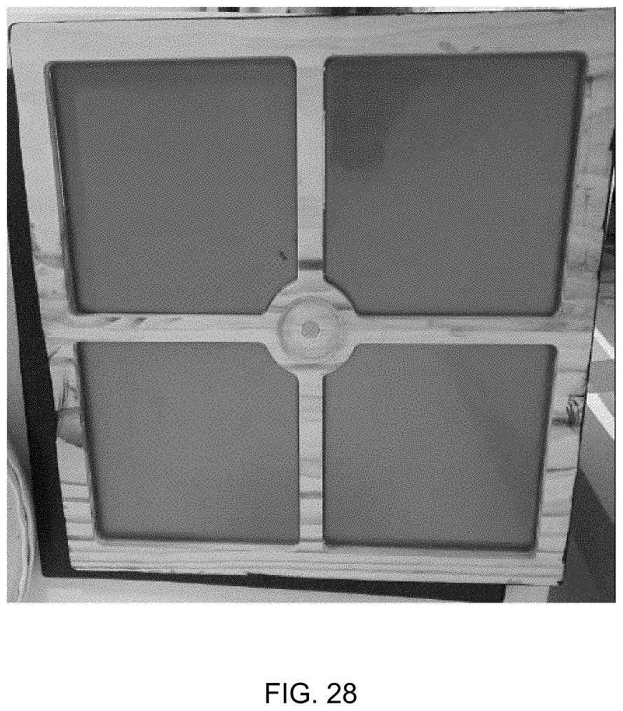

FIG. 28 is a prototype base of which the embodiment of FIG. 9 is representative.

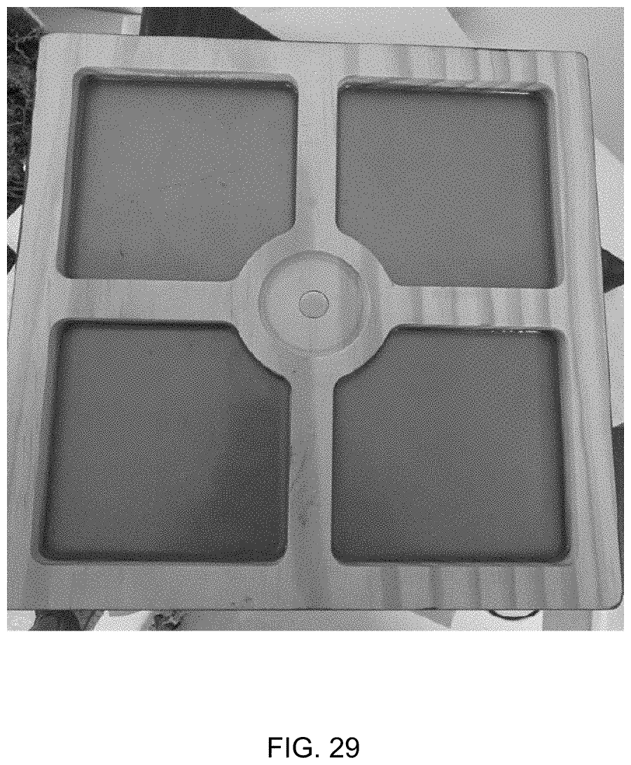

FIG. 29 is a prototype base of which the embodiment of FIG. 9 is representative.

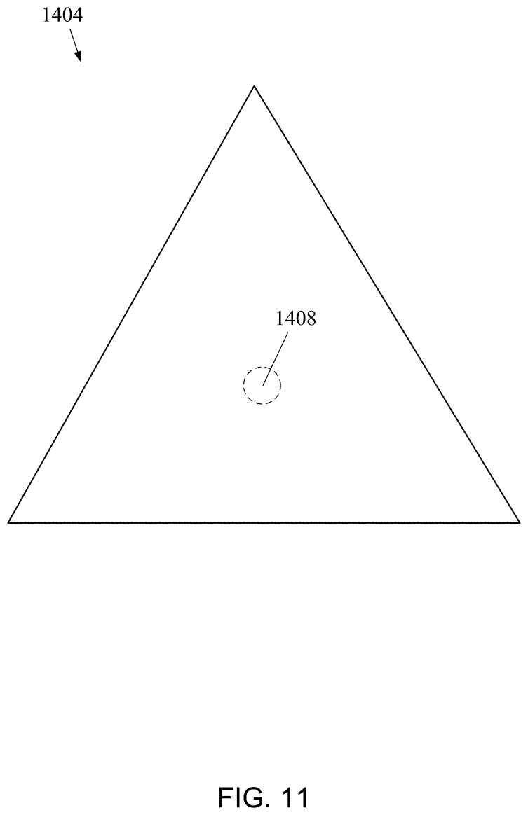

FIG. 11 is a front plan view of a base having a triangular profile of another embodiment in accordance with one or more aspects and features of the invention.

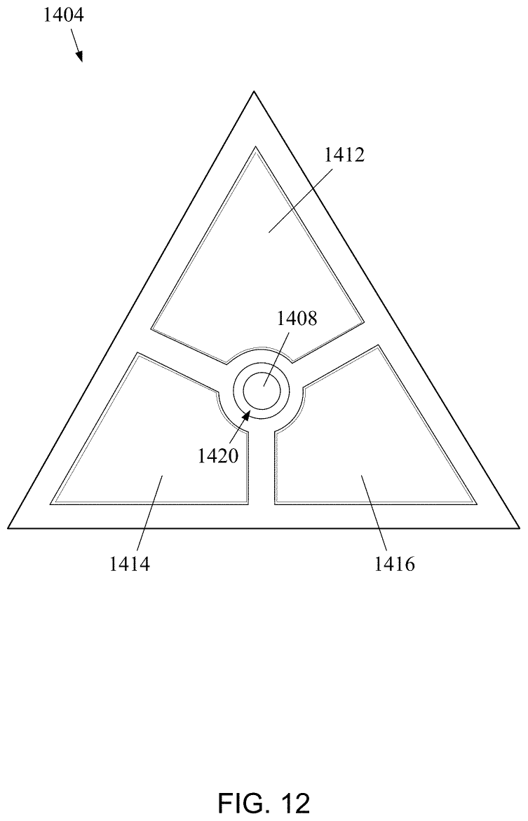

FIG. 12 is a back plan view of the base of FIG. 11.

FIG. 11 is a front plan view of a base 1404 having a triangular profile of another embodiment in accordance with one or more aspects and features of the invention. While similar to base 1004 with respect to having a triangular profile, base 1404 is much larger in dimension than that of base 1004. Additionally, as seen in FIG. 12, which is a back plan view of the base 1404, the base 1404 comprises a wood frame in which three plates 1412,1414,1416 are contained, each made from a ferromagnetic material. Alternatively, the wood frame could contain a single plate or a different plurality of plates of a ferromagnetic material. The base 1404 further comprises a recessed area 1420 designed to receive therein an end of the spacer or spacer/anchor such that the base 1404 is better secured from slipping or otherwise moving when magnetically coupled with the spacer or spacer/anchor.

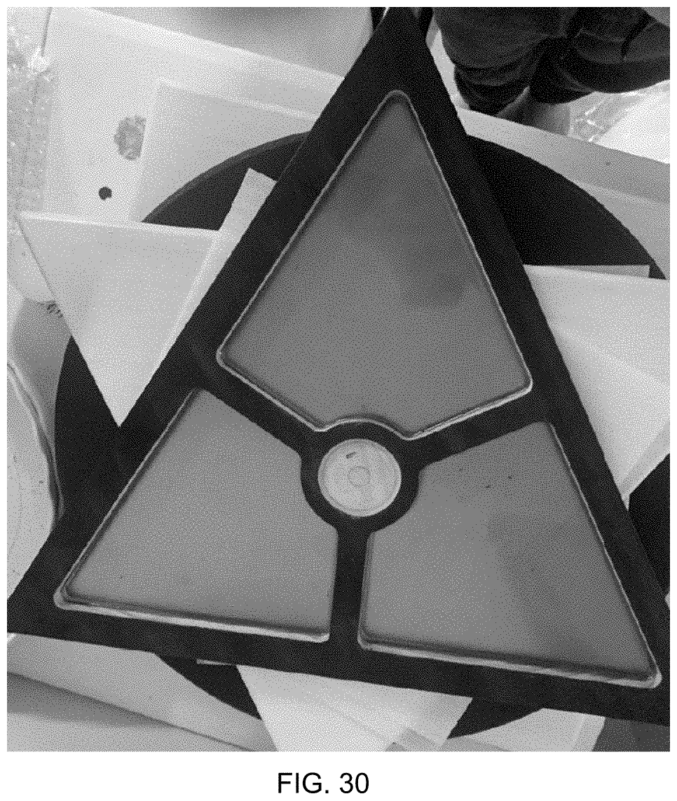

FIG. 30 is a prototype base of which the embodiment of FIG. 11 is representative.

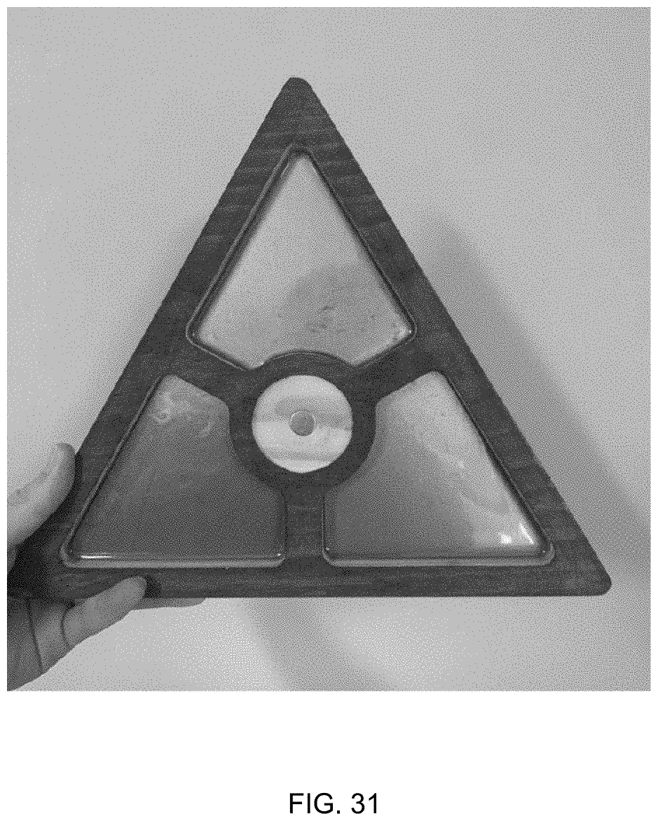

FIG. 31 is a prototype base of which the embodiment of FIG. 11 is representative.

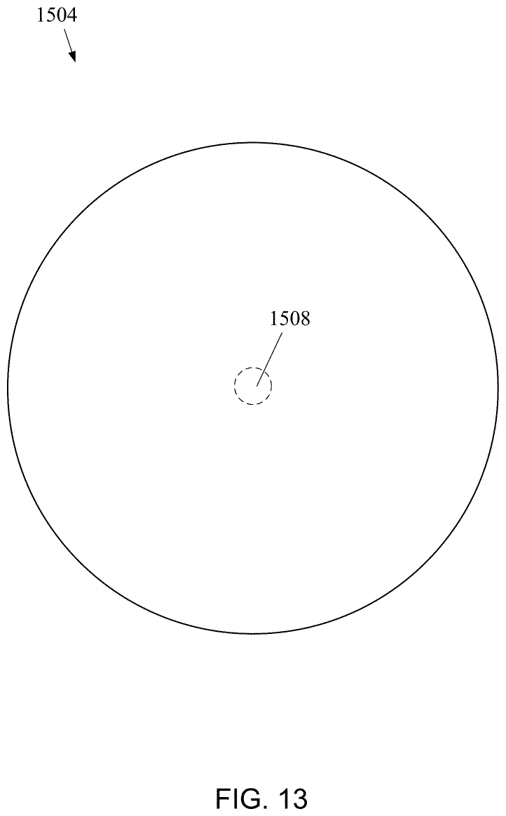

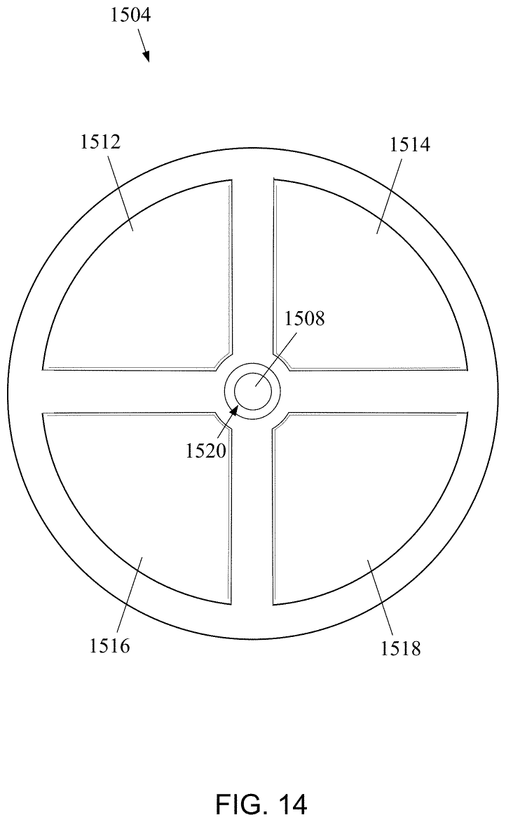

FIG. 13 is a front plan view of a base 1504 having a circular profile of another embodiment in accordance with one or more aspects and features of the invention. While similar to base 1104 with respect to having a circular profile, base 1504 is much larger in dimension than that of base 1104. Additionally, as seen in FIG. 14, which is a back plan view of the base 1504, the base 1504 comprises a wood frame in which four plates 1512,1514,1516,1518 are contained, each made from a ferromagnetic material. Alternatively, the wood frame could contain a single plate or a different plurality of plates of a ferromagnetic material. The base 1504 further comprises a recessed area 1520 designed to receive therein an end of the spacer or spacer/anchor such that the base 1504 is better secured from slipping or otherwise moving when magnetically coupled with the spacer or spacer/anchor.

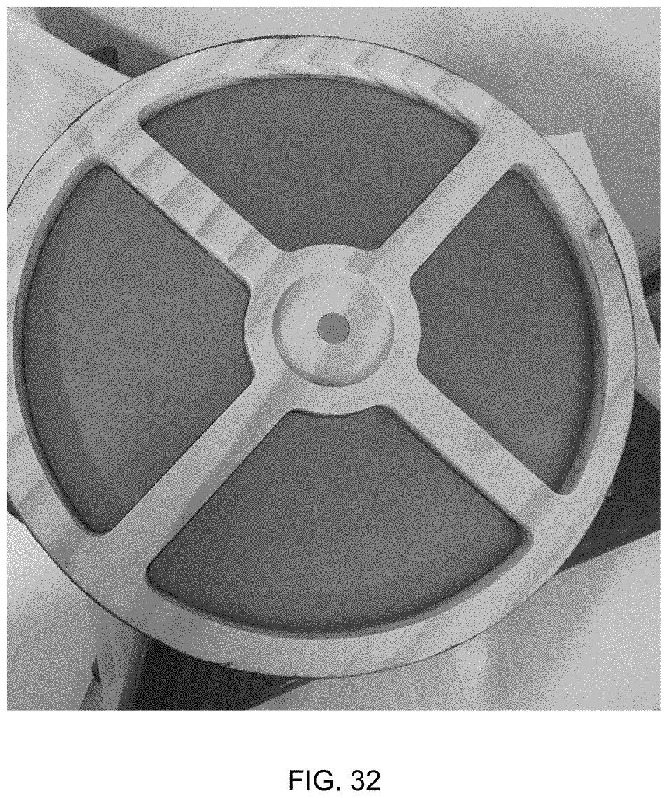

FIG. 32 is a prototype base of which the embodiment of FIG. 13 is representative.

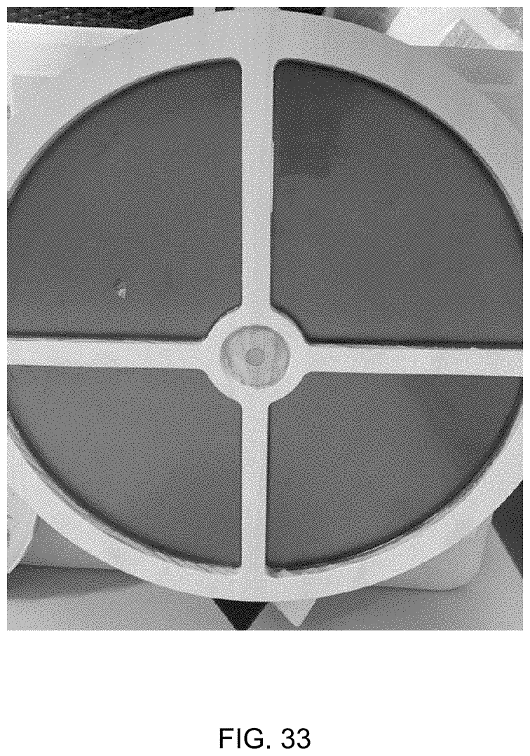

FIG. 33 is a prototype base of which the embodiment of FIG. 13 is representative.

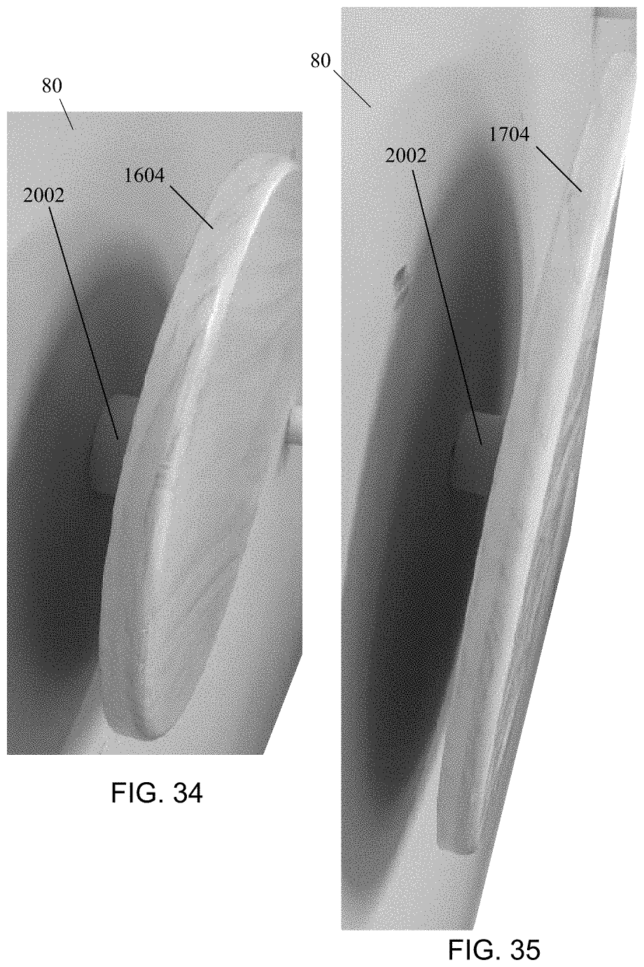

FIG. 34 is side perspective view of a prototype assembly of an embodiment in accordance with one or more aspects and features of the invention in which the base 1604 also has a circular profile, and FIG. 35 is a side perspective view of another prototype assembly of an embodiment in accordance with one or more aspects and features of the invention in which the base 1704 has a larger circular profile. Both circular profiles are larger than that of the base 1104. Nonetheless, each base 1104,1604,1704 is configured for magnetic coupling to the same size spacer or anchor-spacer component 2002 mounted on the wall 80. These bases are thereby interchangeable with the same mechanism for magnetic mounting of the bases to a wall.

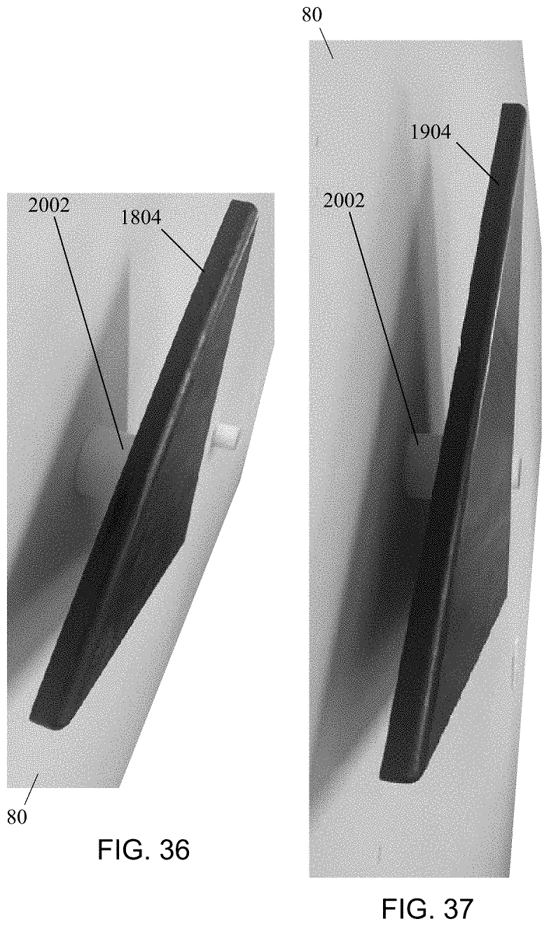

Similarly, FIG. 36 is side perspective view of a prototype assembly of an embodiment in accordance with one or more aspects and features of the invention in which the base 1804 has a triangular profile, and FIG. 37 is a side perspective view of another prototype assembly of an embodiment in accordance with one or more aspects and features of the invention in which the base 1904 has a larger triangular profile. Both triangular profiles are larger than that of the base 1004. Nonetheless, each base 1004,1704,1804 is configured for magnetic coupling to the same size spacer or anchor-spacer component 2002 mounted on the wall 80. These bases are thereby interchangeable with the same mechanism for magnetic mounting of the bases to a wall.

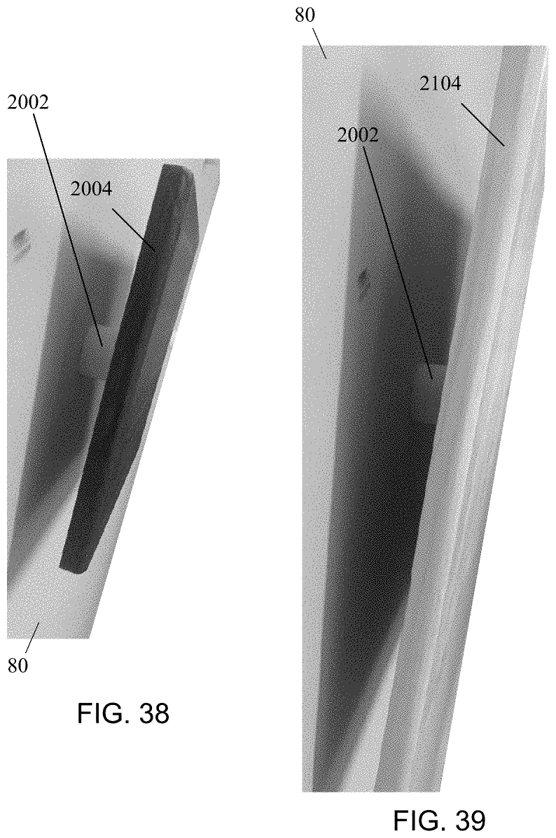

FIG. 38 is side perspective view of a prototype assembly of an embodiment in accordance with one or more aspects and features of the invention in which the base 2004 has a rectangular profile, and FIG. 39 is a side perspective view of another prototype assembly of an embodiment in accordance with one or more aspects and features of the invention in which the base 2104 has a larger rectangular profile. Both rectangular profiles are larger than that of the base 1204. Nonetheless, each base 1204,2004,2104 is configured for magnetic coupling to the same size spacer or anchor-spacer component 2002 mounted on the wall 80. These bases are thereby interchangeable with the same mechanism for magnetic mounting of the bases to a wall. Indeed, all foregoing prototype bases of the drawings are configured for magnetic coupling to the same size spacer or anchor-spacer component and, thus, are interchangeable with the same mechanism for magnetic mounting of the bases to a wall. A base of a different size and/or profile can be changed out for any other base in an assembly.

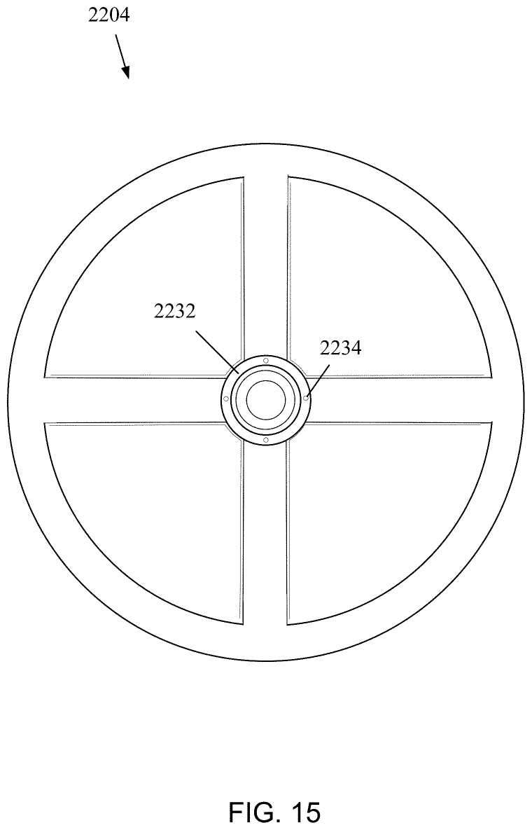

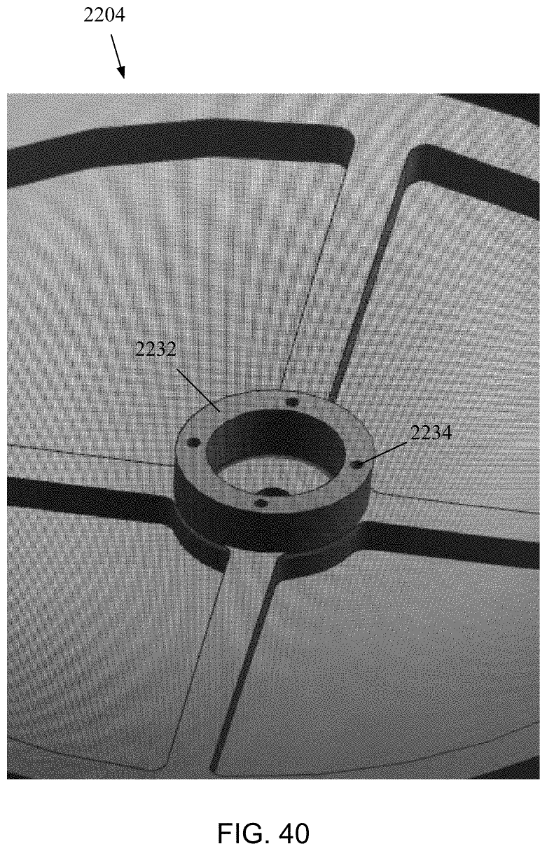

FIG. 15 is a back plan view of a base 2204 with a rectangular profile in accordance with one or more aspects and features of the invention, and FIG. 40 is a back perspective view of the base 2204 wherein a support collar 2232 is seen attached to the base 2204 by screws 2234. The support collar 2232 is configured to receive therein the spacer or anchor-spacer component and provide a more secure connection when the base and spacer or anchor-spacer component are magnetically coupled together. Use of the support collar 2234 is especially preferred for the larger dimensioned bases.

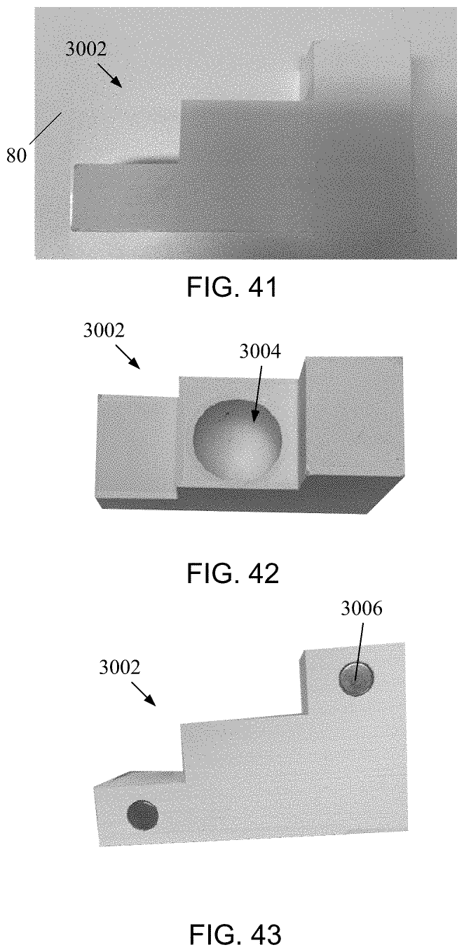

FIG. 41 is a front perspective view of a decorative item 3002 mounted on the wall 80 and comprising a “staircase” in accordance with one or more aspects and features of the invention. FIG. 42 is a top perspective view of the decorative item 3002; and FIG. 43 is a back perspective view of the decorative item 3002. Decorative item 3002 includes a recess 3004 for receiving items or an air plant therein. Decorative item 3002 further comprises one or more magnets 3006 for magnetic coupling thereof in fixed position to a base.

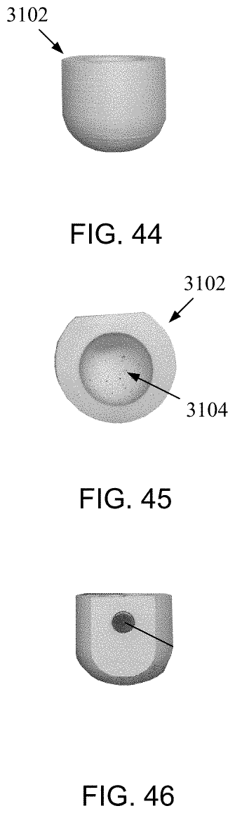

FIG. 44 is a front perspective view of a decorative item 3102 comprising a cup-shaped wall planter in accordance with one or more aspects and features of the invention. FIG. 45 is a top perspective view of the decorative item 3102; and FIG. 46 is a back perspective view of the decorative item 3102. Decorative item 3102 includes a recess 3104 for receiving items or an air plant therein. Decorative item 3102 further comprises one or more magnets 3106 for magnetic coupling thereof in fixed position to a base.

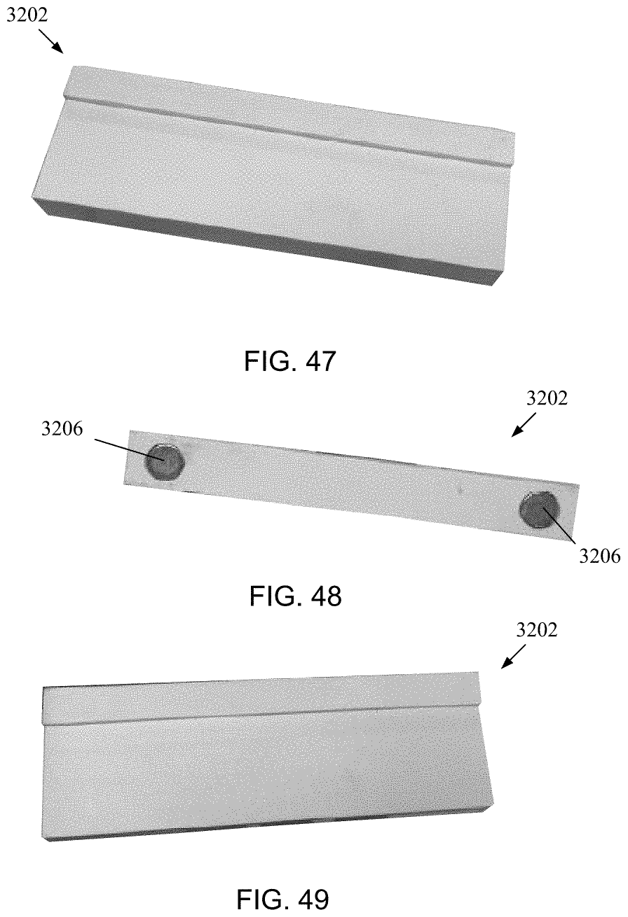

FIG. 47 is a front perspective view of a decorative item 3202 comprising a shelf with channel in accordance with one or more aspects and features of the invention. FIG. 48 is a top perspective view of the decorative item 3202, and FIG. 49 is a back perspective view of the decorative item 3202. Decorative item Decorative item 3202 comprises one or more magnets 3206 for magnetic coupling thereof in fixed position to a base.

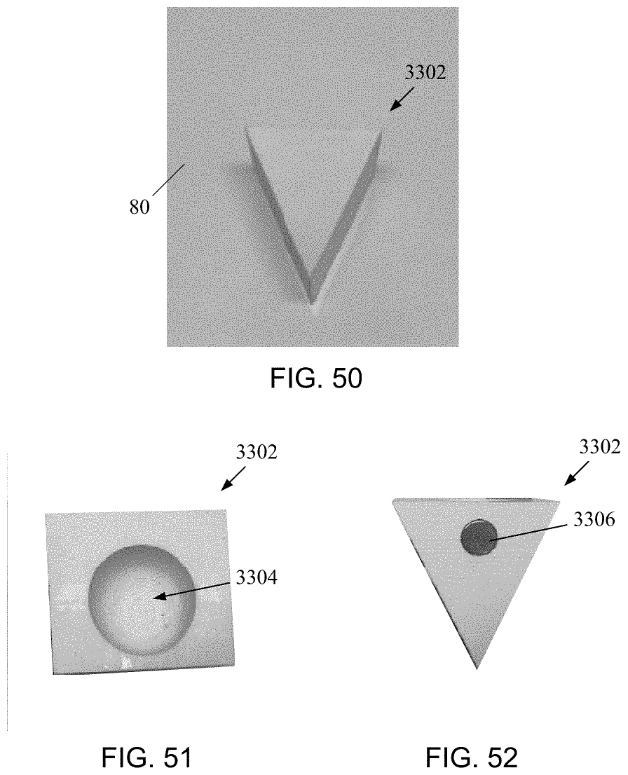

FIG. 50 is a front perspective view of a decorative item 3302 mounted on the wall 80 and comprising a triangular wall planter in accordance with one or more aspects and features of the invention. FIG. 51 is a top perspective view of the decorative item of FIG. 50, and FIG. 52 is a back perspective view of the decorative item of FIG. 50. Decorative item 3302 includes a recess 3304 for receiving items or an air plant therein. Decorative item 3302 further comprises one or more magnets 3306 for magnetic coupling thereof in fixed position to a base.

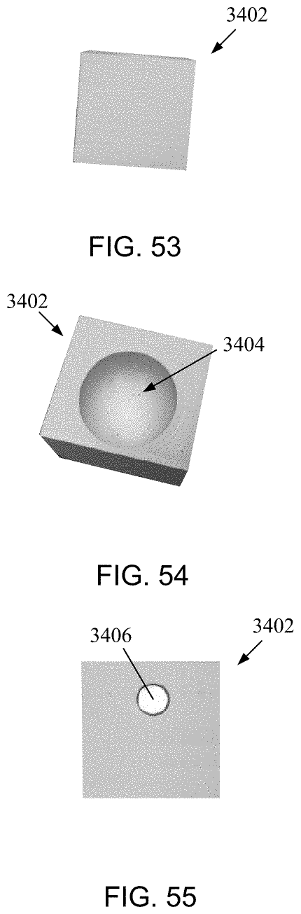

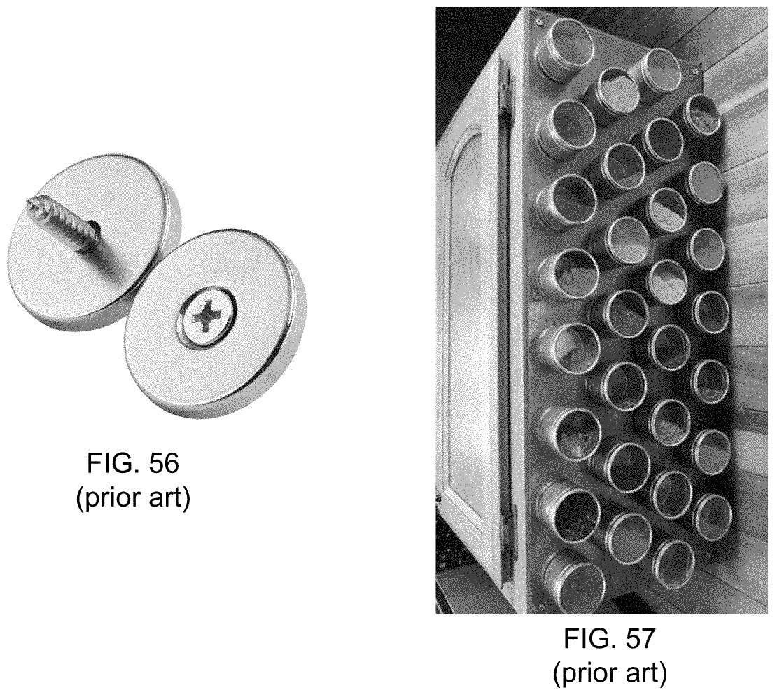

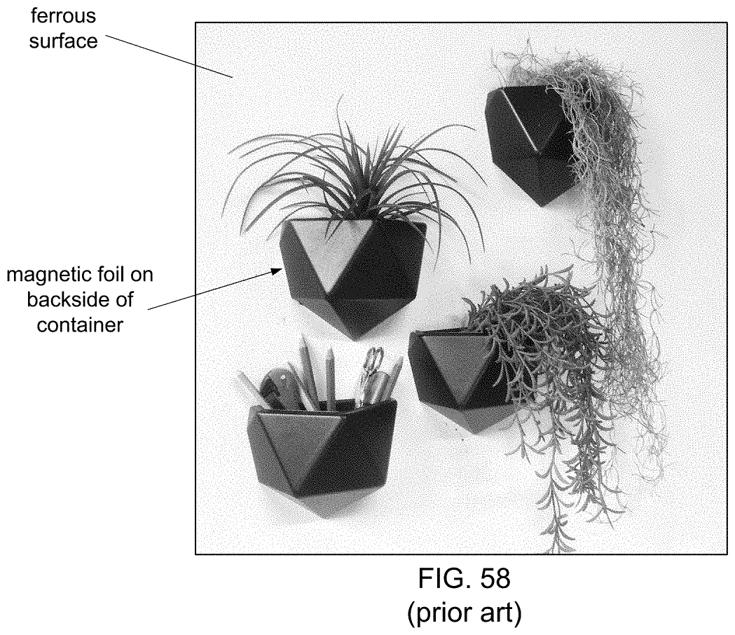

FIG. 53 is a front perspective view of a decorative item 3402 comprising a cubic wall planter in accordance with one or more aspects and features of the invention. FIG. 54 is a top perspective view of the decorative item of FIG. 50, and FIG. 55 is a back perspective view of the decorative item of FIG. 50. Decorative item 3402 includes a recess 3404 for receiving items or an air plant therein. Decorative item 3402 further comprises one or more magnets 3406 for magnetic coupling thereof in fixed position to a base.

In preferred embodiments, the integral anchor-spacer component is 2 inches in length, 2 inches in diameter and 2 inches in height; the smaller rectangular base is 5.5 inches in width and 5.5 inches in length; the smaller circular base is 6 inches in diameter; the smaller triangular base is 5 inches along each side; the intermediate rectangular base is 11 inches in width and 11 inches in length; the intermediate circular base is 11 inches in diameter; the intermediate triangular base is 10.5 inches along each side; the larger rectangular base is 17.5 inches in width and 17.5 inches in length; the larger circular base is 18 inches in diameter; and the larger triangular base is 17 inches along each side.

Based on the foregoing description, it will be readily understood by those persons skilled in the art that the invention has broad utility and application. Many embodiments and adaptations of the invention other than those specifically described herein, as well as many variations, modifications, and equivalent arrangements, will be apparent from or reasonably suggested by the invention and the foregoing descriptions thereof, without departing from the substance or scope of the invention. Accordingly, while the invention has been described herein in detail in relation to one or more preferred embodiments, it is to be understood that this disclosure is only illustrative and exemplary of the invention and is made merely for the purpose of providing a full and enabling disclosure of the invention. The foregoing disclosure is not intended to be construed to limit the invention or otherwise exclude any such other embodiments, adaptations, variations, modifications or equivalent arrangements, the invention being limited only by the claims appended hereto and the equivalents thereof.

1. A magnetic wall-mounted assembly, comprising
(a) an anchor secured to a wall;
(b) a spacer magnetically coupled to the anchor;
(c) a base magnetically coupled to the spacer; and
(d) a decorative item magnetically coupled to the base;
(e) wherein the decorative item and base are separable by pulling the decorative item from the base to decouple them;
(f) wherein the base and spacer are separable by pulling the base from the spacer to decouple them; and
(g) wherein the spacer and the anchor are separable by pulling the spacer from the anchor to decouple them.

2. The magnetic wall-mounted assembly of claim 1, wherein the base comprises a piece of wood, within a back recess of which a ferromagnetic plate is contained for magnetic coupling of the decorative item on a front wooden surface of the base.

3. The magnetic wall-mounted assembly of claim 1, wherein the decorative item comprises a nonmagnetic body within which a magnet is contained for magnetic coupling of the decorative item with the base.

4. The magnetic wall-mounted assembly of claim 3, wherein the non-magnetic body is made from wood.

5. The magnetic wall-mounted assembly of claim 3, wherein the non-magnetic body is made from a plastic material.

6. The magnetic wall-mounted assembly of claim 1, further comprising a support collar secured to the base and surrounding an end of the spacer for supporting the magnetic coupling between the spacer and the base.

7. The magnetic wall-mounted assembly of claim 1, further comprising a gasket secured to an end of the spacer and providing a frictional abutment resisting slippage between the spacer and the base in their magnetic coupling.

8. The magnetic wall-mounted assembly of claim 7, wherein the gasket is made from rubber, silicone, or other non-slip material.

9. The magnetic wall-mounted assembly of claim 1, wherein the spacer is attached to the anchor solely by the magnetic coupling between the spacer and the anchor.

10. The magnetic wall-mounted assembly of claim 1, wherein the base is attached to the spacer solely by the magnetic coupling between the base and the spacer.

11. The magnetic wall-mounted assembly of claim 1, wherein the decorative item is attached to the base solely by the magnetic coupling between the decorative item and the base.

12. The magnetic wall-mounted assembly of claim 1, wherein the decorative item comprises a planter.

13. The magnetic wall-mounted assembly of claim 12, wherein the decorative item further comprises an air plant.

14. The magnetic wall-mounted assembly of claim 1, wherein the decorative item comprises a shelf.

15. The magnetic wall-mounted assembly of claim 1, wherein the decorative item comprises a staircase shelf.

16. The magnetic wall-mounted assembly of claim 1, wherein the base has a triangular profile and hides view of the spacer such that the base appears to be floating proximate the wall.

17. The magnetic wall-mounted assembly of claim 1, wherein the base has a circular profile and hides view of the spacer such that the base appears to be floating proximate the wall.

18. The magnetic wall-mounted assembly of claim 1, wherein the base has a rectangular profile and hides view of the spacer such that the base appears to be floating proximate the wall.

19. The magnetic wall-mounted assembly of claim 1, further comprising additional decorative items, each additional decorative item being magnetically coupled with the base and separable by pulling the additional decorative item from the base to decouple them.

20. The magnetic wall-mounted assembly of claim 1, wherein the base comprises a plurality of ferromagnetic plates each contained within a respective recess of a body of the base, and wherein the magnet of the base is centrally located relative to the plurality of ferromagnetic plates of the base.

21-60. (canceled)
